(19) United States
(12) Patent Application Publication
(10) Pub. No.: US 2025/0040255 A1
(43) Pub. Date: Jan. 30, 2025

(54) I/O CIRCUIT, SEMICONDUCTOR DEVICE, CELL LIBRARY, AND CIRCUIT DESIGNING METHOD FOR SEMICONDUCTOR DEVICE

(71) Applicant: ROHM CO., LTD, Kyoto-shi (JP)

(72) Inventors: Shunta YAMAOKA, Kyoto-shi (JP); Kenichi YOSHIMURA, Kyoto-shi (JP)

(21) Appl. No.: 18/911,842

(22) Filed: Oct. 10, 2024

Related U.S. Application Data
(63) Continuation of application No. PCT/JP2023/016260, filed on Apr. 25, 2023.

(30) Foreign Application Priority Data
Apr. 27, 2022 (JP) 2022-073050

(51) Int. Cl. H01L 27/02; H01L 27/06

(52) U.S. Cl. CPC H01L 27/0255; H01L 27/0207; H01L 27/0617

(57) ABSTRACT

An I/O circuit is formed by combining plural types of standard cells contained in a cell library. For example, the standard cell includes a first element forming region having, formed therein, protection target elements each having a gate electrically connected to an external terminal, a second element forming region arranged in immediate proximity to the external terminal and having first protection elements formed therein, and a third element forming region arranged between the first and second element forming regions and having transistors formed therein. The transistors each have a drain connected to gates of the protection target elements and a source, gate, and back gate all connected to a power supply or ground terminal, thus functioning as a second protection element.

### CROSS-REFERENCE TO RELATED APPLICATIONS

This application is a continuation under 35 U.S.C. § 120 of International Patent Application No. PCT/JP2023/016260 filed on Apr. 25, 2023, which is incorporated herein by reference, and which claimed priority to Japanese Patent Application No. 2022-073050 filed on Apr. 27, 2022. The present application likewise claims priority under 35 U.S.C. § 119 to Japanese Application No. 2022-073050, filed Apr. 27, 2022, the entire content of which is also incorporated herein by reference.

### TECHNICAL FIELD

The disclosure in the present description relates to an I/O [input/output] circuit, a semiconductor device, a cell library, and a circuit designing method for the semiconductor device.

### BACKGROUND ART

There is conventionally known a technique for performing circuit designing of a semiconductor device by arbitrarily combining a plurality of types of standard cells contained in a cell library.

Examples of a conventional technique related to the above can be seen in Patent Documents 1 and 2.

### CITATION LIST

### Patent Literature

Patent Document 1: Japanese Unexamined Patent Application Publication No. 2010-28126
Patent Document 2: Japanese Unexamined Patent Application Publication No. 2010-192932

### BRIEF DESCRIPTION OF DRAWINGS

FIG. 1 is a diagram showing a configuration example of a semiconductor device.

FIG. 2 is a diagram showing a first comparative example of an I/O circuit.

FIG. 3 is a diagram showing a second comparative example of the I/O circuit.

FIG. 4 is a diagram showing a third configuration example of the I/O circuit.

FIG. 5 is a diagram showing a novel embodiment of the I/O circuit.

### DESCRIPTION OF EMBODIMENT

### <Semiconductor Device>

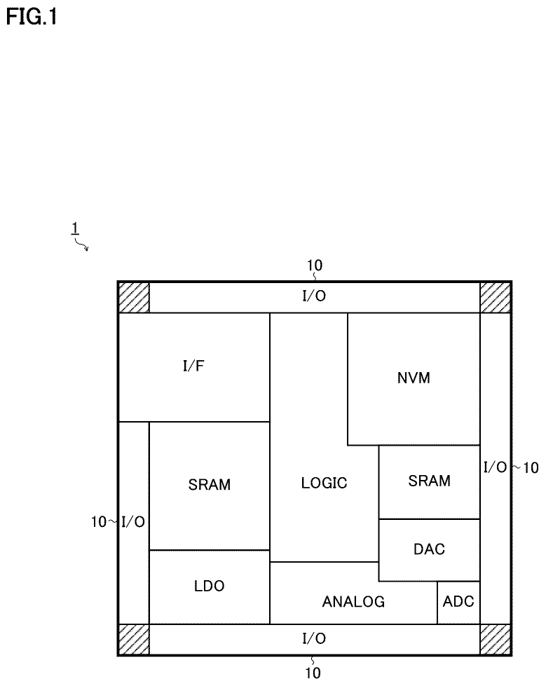

FIG. 1 is a diagram showing a configuration example of a semiconductor device. A semiconductor device 1 according to this configuration example is an LSI mainly integrating CMOS [complementary MOS] circuits (logic/analog mixed circuits) driven at a voltage of not more than 5 V. Arranged on an outermost circumference of the semiconductor device 1 are I/O circuits 10 each taking on an ESD protection function and a signal input/output function.

The semiconductor device 1 integrates various internal circuits in addition to the I/O circuits 10. With reference to this drawing, as the various internal circuits, a logic circuit LOGIC, an analog circuit ANALOG, an interface circuit I/F, a nonvolatile memory NVM, volatile memories SRAM, a digital/analog converter DAC, an analog/digital converter ADC, and a regulator LDO are integrated in the semiconductor device 1.

In a planar view of the semiconductor device 1, the I/O circuits 10 may be arranged along four sides of the semiconductor device 1 so as to enclose the above-described internal circuits.

The semiconductor device 1 can be, for example, a unified communication IC [integrated circuit] designed to be vehicle-mounted for controlling, upon receipt of instructions via a vehicle-mounted network, controllers (an ECU [electronic control unit] and so on) mounted in various types of terminal equipment (such as an LED [light emitting diode] lamp, a motor, or a switch). In this case, the interface circuit I/F may comply with an arbitrary vehicle-mounted network (examples of which include a LIN [local interconnect network], a CXPI [clock extension peripheral interface], and a CAN [controller area network]).

### I/O Circuit (First Comparative Example)

First, prior to describing a novel embodiment of the I/O circuit 10, a brief description is now given of an electrostatic protection function required of the I/O circuit 10 (the necessity of a secondary clamp therein). Modeled types of ESD include MM [machine model] and CDM [charged device model]. The MM refers to a standardized phenomenon of charge release from a charged metal to an IC. The CDM, on the other hand, refers to a standardized phenomenon of charge release from a charged IC to another conductor. An MM pulse and a CDM pulse each have an attenuation vibration waveform whose cycle is shorter than that of a waveform of any other type of ESD pulse.

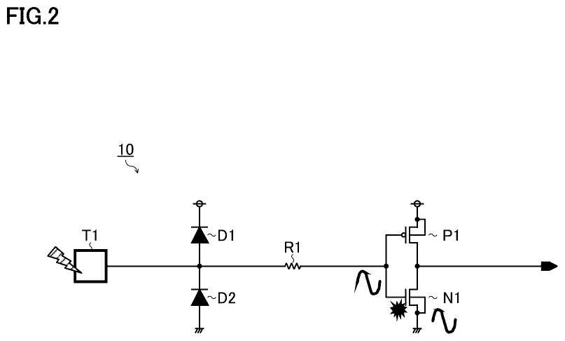

FIG. 2 is a diagram showing a first comparative example of the I/O circuit 10. An I/O circuit 10 according to this comparative example includes electrostatic protection diodes D1 and D2 and a current limiting resistor R1 that are used to protect, from electrostatic breakdown, protection target elements (in this drawing, a P-channel transistor P1 (for example, a PMOSFET) and an N-channel transistor N1 (for example, an NMOSFET)) each having a gate electrically connected to an external terminal T1.

The external terminal T1 is a terminal other than a power supply terminal and a ground terminal and may be, for example, a signal input terminal, a signal output terminal, or a signal input/output terminal.

In the I/O circuit 10 according to this comparative example, for example, when an ESD pulse (a CDM pulse) is applied to the external terminal T1, even though the electrostatic protection diodes D1 and D2 are provided, a potential difference (a phase shift) between a gate and a back gate of the transistor N1 may be increased. As a result, an overvoltage might be applied to a gate oxide film of the transistor N1, causing breakdown of the transistor N1 or a shift in characteristics thereof.

Furthermore, though not shown, the transistor P1 may also suffer from a trouble similar to the above. That is, when an ESD pulse (an MM pulse or a CDM pulse) is applied to the external terminal T1, there might occur breakdown of the transistor P1 or a characteristic shift thereof.

### I/O Circuit (Second Comparative Example)

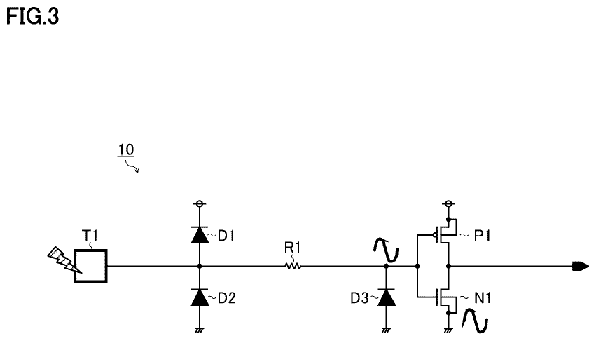

FIG. 3 is a diagram showing a second comparative example of the I/O circuit 10. An I/O circuit 10 according to this comparative example has a configuration based on the earlier described first comparative example (FIG. 2) and further including an electrostatic protection diode D3.

The I/O circuit 10 according to this comparative example includes, separately from electrostatic protection diodes D1 and D2 arranged in immediate proximity to an external terminal T1, the electrostatic protection diode D3 arranged in immediate proximity to a gate of a transistor N1 so that, even when an ESD pulse (an MM pulse or a CDM pulse) is applied to the external terminal T1, breakage of the transistor N1 or a characteristic shift thereof is prevented from occurring.

When an ESD pulse (an MM pulse or a CDM pulse) is applied to the external terminal T1, the electrostatic protection diode D3 causes a current flow so as to suppress an increase in gate potential of the transistor N1, thus serving to provide protection between the gate and a back gate of the transistor N1 from electrostatic breakdown. The electrostatic protection diode D3 thus configured is referred to as a secondary clamp.

Furthermore, though not shown, there may be provided a secondary clamp between a gate and a back gate of the transistor P1.

Providing the secondary clamp in the I/O circuit 10, however, requires the electrostatic protection diode D3 (or a diode-connected MOSFET) to be prepared separately from the electrostatic protection diodes D1 and D2. This leads to an increase in area of the I/O circuit 10.

### I/O Circuit (Third Comparative Example)

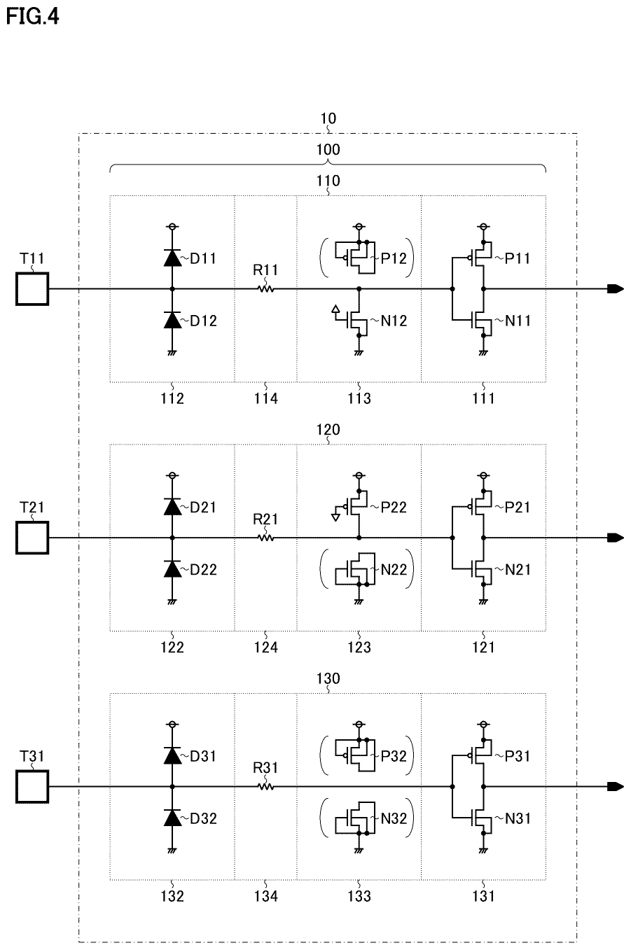

FIG. 4 is a diagram showing a third comparative example (=a general configuration example for comparison with the embodiment described later) of the I/O circuit 10. This drawing basically depicts a circuit diagram of the I/O circuit 10. When attention is focused on a short dashed line frame, however, this drawing can also be understood as depicting a schematic circuit layout in a planar view of the I/O circuit 10.

An I/O circuit 10 according to this comparative example is formed by arbitrarily combining a plurality of types of standard cells contained in an I/O cell library 100. The I/O cell library 100 is read out from a circuit designing program executed on a computer and can be understood as a type of database for circuit designing.

Each of the above-described plurality of types of standard cells has interface functions (the ESD protection function and the signal input/output function) of interfacing with an exterior of the device. Furthermore, the above-described plurality of types of standard cells are standardized in terms of their shape and layout so that, even when any of the standard cells is replaced with another standard cell, there is no need to modify surrounding standard cells arranged around the any of the standard cells.

A brief description is now given of a circuit designing method for the semiconductor device 1 (particularly, the I/O circuit 10) using the I/O cell library 100. First, there is executed a step of selecting, arranging, and thereby arbitrarily combining a plurality of types of standard cells contained in the I/O cell library 100. Next, there is executed a step of laying a power supply line, a signal line, and so on so as to establish connection between the plurality of types of standard cells thus arbitrarily combined and any other circuit block. Finally, there is executed a step of verifying whether a thus designed circuit satisfies desired conditions (such as electrical characteristics).

The I/O cell library 100 thus configured is used to perform circuit designing of the semiconductor device 1 (particularly, the I/O circuit 10), and thus it is no longer needed to design, for each terminal, ESD immunity, latch-up immunity, electrical characteristics, and so on. Accordingly, it is possible to reduce a burden on a circuit designer and to reduce design errors.

With reference to this drawing, the I/O circuit 10 according to this comparative example is formed by combining three different types of I/O cells 110, 120, and 130 as the above-described plurality of types of standard cells.

The I/O cells 110, 120, and 130 have multiple parts in common. Thus, in giving a description common to all of the I/O cells 110, 120, and 130, each constituent element is denoted by a reference sign including a character “*” (where *=1, 2, or 3) inserted therein, and a duplicate description thereof is thereby omitted as much as possible.

An I/O cell 1*0 includes a first element forming region 1*1, a second element forming region 1*2, a third element forming region 1*3, and a fourth element forming region 1*4.

In the first element forming region 1*1, as protection target elements each having a gate electrically connected to an external terminal T*1, a P-channel transistor P*1 (for example, a PMOSFET) and an N-channel transistor N*1 (for example, an NMOSFET) are formed.

A source and a back gate of the transistor P*1 are both connected to a power supply terminal. A source and a back gate of the transistor N*1 are both connected to a ground terminal. Respective drains of the transistors P*1 and N*1 are both connected to an output terminal. Respective gates of the transistors P*1 and N*1 are both connected to the external terminal T*1 via a current limiting resistor R*1. The transistors P*1 and N*1 thus connected constitute a CMOS inverter (a so-called I/O buffer).

The second element forming region 1*2 is arranged in immediate proximity to the external terminal T*1. In the second element forming region 1*2, as first protection elements for protecting the transistors P*1 and N*1 from electrostatic breakdown, electrostatic protection diodes D*1 and D*2 are formed.

An anode of the electrostatic protection diode D*1 is connected to the external terminal T*1. A cathode of the electrostatic protection diode D*1 is connected to a power supply terminal. In this manner, as a first upper protection element, the electrostatic protection diode D*1 is connected between the respective gates of the transistors P*1 and N*1 and the power supply terminal.

A cathode of the electrostatic protection diode D*2 is connected to the external terminal T*1. An anode of the electrostatic protection diode D*2 is connected to a ground terminal. In this manner, as a first lower protection element, the electrostatic protection diode D*2 is connected between the respective gates of the transistors P*1 and N*1 and the ground terminal.

The third element forming region 1*3 is arranged between the first element forming region 1*1 and the second element forming region 1*2 (with reference to this drawing, between the first element forming region 1*1 and the fourth element forming region 1*4). In the third element forming region 1*3, a P-channel transistor P*2 (for example, a PMOSFET) and an N-channel transistor N*2 (for example, an NMOSFET) are formed. A connection relationship between the transistors P*2 and N*2 varies among the I/O cells 110, 120, and 130 and will therefore be described later separately.

The fourth element forming region 1*4 is arranged between the first element forming region 1*1 and the second element forming region 1*2 (with reference to this drawing, between the third element forming region 1*3 and the second element forming region 1*2). In the fourth element forming region 1*4, there is formed the current limiting resistor R*1 connected between the respective gates of the transistors P*1 and N*1 and the external terminal T*1.

In the planar view of the I/O circuit 10, the I/O cells 110, 120, and 130 are formed in the same rectangular shape and are arrayed in a shown order from an upper side in the drawing.

When viewed in more detail, in the planar view of the I/O circuit 10, first element forming regions 111, 121, and 131 are formed in the same rectangular shape and are arrayed in a shown order from the upper side in the drawing. The same holds true for the second element forming region 1*2, the third element forming region 1*3, and the fourth element forming region 1*4.

A description is further given of a difference (in the connection relationship between the transistors P*2 and N*2) among the I/O cells 110, 120, and 130.

First, the description focuses on a third element forming region 113 of the I/O cell 110. A source, a drain, a gate, and a back gate of a transistor P12 are all connected to a power supply terminal. That is, as a dummy transistor having no function, the transistor P12 is isolated from respective gates of transistors P11 and N11.

On the other hand, a drain of a transistor N12 is connected to the respective gates of the transistors P11 and N11. A source and a back gate of the transistor N12 are both connected to a ground terminal. A gate of the transistor N12 is connected to a bias potential terminal (for example, an intermediate potential between a power supply potential and a ground potential). The transistor N12 thus connected functions as a pull-down element (=a pull-down resistor) for pulling down the respective gates of the transistors P11 and N11 to the ground potential when an external terminal T11 is in an open state (a high impedance state).

Furthermore, between the drain and the source of the transistor N12, there is additionally provided a body diode using the drain of the transistor N12 as a cathode and the back gate of the transistor N12 as an anode. The transistor N12, therefore, functions also as a secondary clamp (=corresponding to a second lower protection element) that provides protection between the gate and a back gate of the transistor N11 from electrostatic breakdown.

Next, the description focuses on a third element forming region 123 of the I/O cell 120. A source, a drain, a gate, and a back gate of a transistor N22 are all connected to a ground terminal. That is, as a dummy transistor having no function, the transistor N22 is isolated from respective gates of transistors P21 and N21.

On the other hand, a drain of a transistor P22 is connected to the respective gates of the transistors P21 and N21. A source and a back gate of the transistor P22 are both connected to a power supply terminal. A gate of the transistor P22 is connected to a bias potential terminal (for example, an intermediate potential between a power supply potential and a ground potential). The transistor P22 thus connected functions as a pull-up element (=a pull-up resistor) for pulling up the respective gates of the transistors P21 and N21 to the power supply potential when an external terminal T21 is in the open state (the high impedance state).

Furthermore, between the drain and the source of the transistor P22, there is additionally provided a body diode using the drain of the transistor P22 as an anode and the back gate of the transistor P22 as a cathode. The transistor P22, therefore, functions also as a secondary clamp (=a second upper protection element) that provides protection between the gate and a back gate of the transistor P21 from electrostatic breakdown.

Next, the description focuses on a third element forming region 133 of the I/O cell 130. A source, a drain, a gate, and a back gate of a transistor P32 are all connected to a power supply terminal. Furthermore, a source, a drain, a gate, and a back gate of a transistor N32 are all connected to a ground terminal. That is, as a dummy transistor having no function, each of the transistors P32 and N32 is isolated from respective gates of transistors P31 and N31.

To summarize the above, in the I/O circuit 10 according to this comparative example, the I/O cell 110 is additionally equipped with a pull-down function exerted by the transistor N12. Furthermore, the I/O cell 120 is additionally equipped with a pull-up function exerted by the transistor P22. On the other hand, in the I/O cell 130, the transistors P32 and N32 are both used as dummy transistors, and thus the pull-up function and the pull-down function are both disabled.

As described above, a plurality of types of standard cells (in this drawing, the I/O cells 110, 120, and 130) contained in the I/O cell library 100 are arbitrarily combined, and thus a wide variety of I/O circuits 10 can be designed to meet respective specifications of the external terminals T11, T21, and T31.

The I/O cell 130 having neither the pull-up function nor the pull-down function, however, is brought into a state of having no secondary clamp. Because of this, in a case where an ESD pulse (a CDM pulse) is applied to the external terminal T31, similarly to the earlier described first comparative example (FIG. 2), there might occur breakdown of each of the transistors P31 and N31 or a characteristic shift thereof.

Furthermore, the I/O cells 110 and 120 also have only either an upper secondary clamp or a lower secondary clamp. It can, therefore, hardly be said that a sufficient ESD countermeasure (MM countermeasure or CDM countermeasure) has been taken.

The following proposes a novel embodiment effectively utilizing the third element forming region 1*3, thus making it possible to achieve both of an improvement in ESD immunity and an area reduction.

### I/O Circuit (Embodiment)

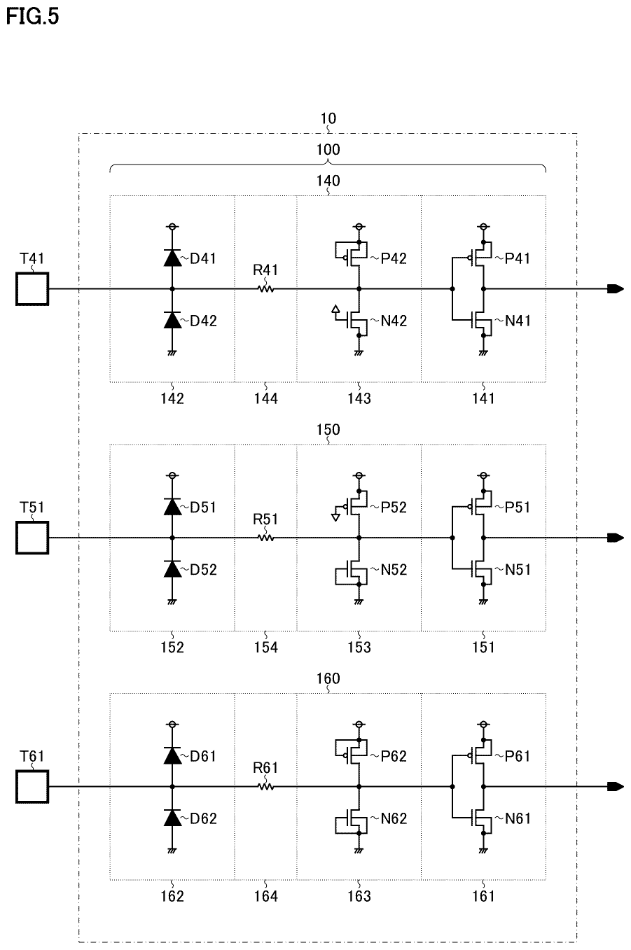

FIG. 5 is a diagram showing the novel embodiment of the I/O circuit 10. Similarly to the earlier described third comparative example (FIG. 4), an I/O circuit 10 according to this embodiment is formed by combining three different types of I/O cells 140, 150, and 160 contained in an I/O cell library 100.

The I/O cells 140, 150, and 160 have multiple parts in common. Thus, in giving a description common to all of the I/O cells 140, 150, and 160, each constituent element is denoted by a reference sign including a character “#” (where #=4, 5, or 6) inserted therein, and a duplicate description thereof is thereby omitted as much as possible.

An I/O cell 1 #0 includes a first element forming region 1 #1, a second element forming region 1 #2, a third element forming region 1 #3, and a fourth element forming region 1 #4.

In the first element forming region 1 #1, as protection target elements each having a gate electrically connected to an external terminal T #1, a P-channel transistor P #1 (for example, a PMOSFET) and an N-channel transistor N #1 (for example, an NMOSFET) are formed.

A source and a back gate of the transistor P #1 are both connected to a power supply terminal. A source and a back gate of the transistor N #1 are both connected to a ground terminal. Respective drains of the transistors P #1 and N #1 are both connected to an output terminal. Respective gates of the transistors P #1 and N #1 are both connected to the external terminal T #1 via a current limiting resistor R #1. The transistors P #1 and N #1 thus connected constitute a CMOS inverter (a so-called I/O buffer).

The second element forming region 1 #2 is arranged in immediate proximity to the external terminal T #1. In the second element forming region 1 #2, as first protection elements for protecting the transistors P #1 and N #1 from electrostatic breakdown, electrostatic protection diodes D #1 and D #2 are formed.

An anode of the electrostatic protection diode D #1 is connected to the external terminal T #1. A cathode of the electrostatic protection diode D #1 is connected to a power supply terminal. In this manner, as a first upper protection element, the electrostatic protection diode D #1 is connected between the respective gates of the transistors P #1 and N #1 and the power supply terminal.

A cathode of the electrostatic protection diode D #2 is connected to the external terminal T #1. An anode of the electrostatic protection diode D #2 is connected to a ground terminal. In this manner, as a first lower protection element, the electrostatic protection diode D #2 is connected between the respective gates of the transistors P #1 and N #1 and the ground terminal.

The third element forming region 1 #3 is arranged between the first element forming region 1 #1 and the second element forming region 1 #2 (with reference to this drawing, between the first element forming region 1 #1 and the fourth element forming region 1 #4). In the third element forming region 1 #3, a P-channel transistor P #2 (for example, a PMOSFET) and an N-channel transistor N #2 (for example, an NMOSFET) are formed. A connection relationship between the transistors P #2 and N #2 varies among the I/O cells 140, 150, and 160 and will therefore be described later separately.

The fourth element forming region 1 #4 is arranged between the first element forming region 1 #1 and the second element forming region 1 #2 (with reference to this drawing, between the third element forming region 1 #3 and the second element forming region 1 #2). In the fourth element forming region 1 #4, there is formed the current limiting resistor R #1 connected between the respective gates of the transistors P #1 and N #1 and the external terminal T #1.

In the planar view of the I/O circuit 10, the I/O cells 140, 150, and 160 are formed in the same rectangular shape and are arrayed in a shown order from an upper side in the drawing.

When viewed in more detail, in the planar view of the I/O circuit 10, first element forming regions 141, 151, and 161 are formed in the same rectangular shape and are arrayed in a shown order from the upper side in the drawing. The same holds true for the second element forming region 1 #2, the third element forming region 1 #3, and the fourth element forming region 1 #4.

A description is further given of a difference (in the connection relationship between the transistors P #2 and N #2) among the I/O cells 140, 150, and 160.

First, the description focuses on a third element forming region 143 of the I/O cell 140. A source, a gate, and a back gate of a transistor P42 are all connected to a power supply terminal. A drain of the transistor P42 is connected to respective gates of transistors P41 and N41. Between the drain and the source of the transistor P42, there is additionally provided a body diode using the drain of the transistor P42 as an anode and the back gate of the transistor P42 as a cathode. The transistor P42, therefore, functions as a secondary clamp (=corresponding to a second upper protection element) that provides protection between the gate and a back gate of the transistor P41 from electrostatic breakdown.

On the other hand, a drain of a transistor N42 is connected to the respective gates of the transistors P41 and N41. A source and a back gate of the transistor N42 are both connected to a ground terminal. A gate of the transistor N42 is connected to a bias potential terminal (for example, an intermediate potential between a power supply potential and a ground potential). The transistor N42 thus connected functions as a pull-down element (=a pull-down resistor) for pulling down the respective gates of the transistors P41 and N41 to the ground potential when an external terminal T41 is in an open state (a high impedance state).

Furthermore, between the drain and the source of the transistor N42, there is additionally provided a body diode using the drain of the transistor N42 as a cathode and the back gate of the transistor N42 as an anode. The transistor N42, therefore, functions also as a secondary clamp (=a second lower protection element) that provides protection between the gate and a back gate of the transistor N41 from electrostatic breakdown.

Next, the description focuses on a third element forming region 153 of the I/O cell 150. A drain of a transistor P52 is connected to respective gates of transistors P51 and N51. A source and a back gate of the transistor P52 are both connected to a power supply terminal. A gate of the transistor P52 is connected to a bias potential terminal (for example, an intermediate potential between a power supply potential and a ground potential). The transistor P52 thus connected functions as a pull-up element (=a pull-up resistor) for pulling up the respective gates of the transistors P51 and N51 to the power supply potential when an external terminal T51 is in the open state (the high impedance state).

Furthermore, between the drain and the source of the transistor P52, there is additionally provided a body diode using the drain of the transistor P52 as an anode and the back gate of the transistor P52 as a cathode. Accordingly, the transistor P52 functions also as a secondary clamp (=a secondary upper protection element) that provides protection between the gate and a back gate of the transistor P51 from electrostatic breakdown.

On the other hand, a source, a gate, and a back gate of a transistor N52 are all connected to a ground terminal. A drain of the transistor N52 is connected to the respective gates of the transistors P51 and N51. Between the drain and the source of the transistor N52, there is additionally provided a body diode using the drain of the transistor N52 as a cathode and the back gate of the transistor N52 as an anode. The transistor N52, therefore, functions as a secondary clamp (=corresponding to a second lower protection element) that provides protection between the gate and a back gate of the transistor N51 from electrostatic breakdown.

Finally, the description focuses on a third element forming region 163 of the I/O cell 160. A source, a gate, and a back gate of a transistor P62 are all connected to a power supply terminal. A drain of the transistor P62 is connected to respective gates of transistors P61 and N61. Between the drain and the source of the transistor P62, there is additionally provided a body diode using the drain of the transistor P62 as an anode and the back gate of the transistor P62 as a cathode. The transistor P62, therefore, functions as a secondary clamp (=corresponding to a second upper protection element) that provides protection between the gate and a back gate of the transistor P61 from electrostatic breakdown.

On the other hand, a source, a gate, and a back gate of a transistor N62 are all connected to a ground terminal. A drain of the transistor N62 is connected to the respective gates of the transistors P61 and N61. Between the drain and the source of the transistor N62, there is additionally provided a body diode using the drain of the transistor N62 as a cathode and the back gate of the transistor N62 as an anode. The transistor N62, therefore, functions as a secondary clamp (=corresponding to a second lower protection element) that provides protection between the gate and a back gate of the transistor N61 from electrostatic breakdown.

To summarize the above, in the I/O circuit 10 according to this embodiment, the I/O cell 140 is additionally equipped with an upper secondary clamp function exerted by the transistor P42 and a pull-down function and a lower secondary clamp function exerted by the transistor N42. Furthermore, the I/O cell 150 is additionally equipped with a pull-up function and the upper secondary clamp function exerted by the transistor P52 and the lower secondary clamp function exerted by the transistor N52. On the other hand, the I/O cell 160 is additionally equipped with the upper secondary clamp function exerted by the transistor P62 and the lower secondary clamp function exerted by the transistor N62.

As described above, in the I/O circuit 10 according to this embodiment, when not used as a pull-up element or a pull-down element, each of the transistors P #2 and N #2 formed in the third element forming region 1 #3 of the I/O cell 1 #0 is effectively utilized as a secondary clamp instead of being used as a dummy transistor. Accordingly, it is possible to further enhance the ESD countermeasure (the MM countermeasure or the CDM countermeasure) without causing an increase in area of the I/O cell 1 #0, thus making it possible to achieve both of an improvement in ESD immunity and an area reduction.

### <Overview>

To follow is an overview of the above-described various modes of embodiment.

For example, an I/O circuit as disclosed in the present description is formed by arbitrarily combining a plurality of types of standard cells contained in a cell library and has a configuration (a first configuration) in which at least one of the plurality of types of standard cells includes a first element forming region configured so that a protection target element having a gate electrically connected to an external terminal is formed therein, a second element forming region arranged in immediate proximity to the external terminal and configured so that a first protection element for protecting the protection target element from electrostatic breakdown is formed therein, and a third element forming region arranged between the first element forming region and the second element forming region and configured so that a first transistor and a second transistor are formed therein. At least one of the first transistor and the second transistor has a drain connected to a gate of the protection target element and a source, a gate, and a back gate all connected to a constant potential terminal, thus functioning as a second protection element for protecting the protection target element from electrostatic breakdown.

The I/O circuit according to the above-described first configuration may have a configuration (a second configuration) in which the first protection element includes a first upper protection element configured to be connected between the gate of the protection target element and a power supply terminal and a first lower protection element configured to be connected between the gate of the protection target element and a ground terminal.

Furthermore, the I/O circuit according to the above-described first or second configuration may have a configuration (a third configuration) in which the first transistor has a drain connected to the gate of the protection target element and a source, a gate, and a back gate all connected to a power supply terminal, thus functioning as a second upper protection element, and the second transistor has a drain connected to the gate of the protection target element, a source and a back gate both connected to a ground terminal, and a gate connected to a bias potential terminal, thus functioning as a pull-down element and a second lower protection element.

Furthermore, the I/O circuit according to the above-described first or second configuration may have a configuration (a fourth configuration) in which the first transistor has a drain connected to the gate of the protection target element, a source and a back gate both connected to a power supply terminal, and a gate connected to a bias potential terminal, thus functioning as a pull-up element and a second upper protection element, and the second transistor has a drain connected to the gate of the protection target element and a source, a gate, and a back gate all connected to a ground terminal, thus functioning as a second lower protection element.

Furthermore, the I/O circuit according to the above-described first or second configuration may have a configuration (a fifth configuration) in which the first transistor has a drain connected to the gate of the protection target element and a source, a gate, and a back gate all connected to a power supply terminal, thus functioning as a second upper protection element, and the second transistor has a drain connected to the gate of the protection target element and a source, a gate, and a back gate all connected to a ground terminal, thus functioning as a second lower protection element.

Furthermore, the I/O circuit according to any of the above-described first to fifth configurations may have a configuration (a sixth configuration) in which the protection target element includes a P-channel transistor configured to have a source and a back gate both connected to a power supply terminal, a drain connected to an output terminal, and a gate connected to the external terminal and an N-channel transistor configured to have a drain connected to the output terminal, a source and a back gate both connected to a ground terminal, and a gate connected to the external terminal.

Furthermore, the I/O circuit according to any of the above-described first to sixth configurations may have a configuration (a seventh configuration) further including a fourth element forming region arranged between the first element forming region and the second element forming region and configured so that a current limiting resistor connected between the gate of the protection target element and the external terminal is formed therein.

Furthermore, for example, a semiconductor device as disclosed in the present description has a configuration (an eighth configuration) including the I/O circuit according to any of the above-described first to seventh configurations.

Furthermore, for example, a cell library as disclosed in the present description is read out from a circuit designing program executed on a computer and contains a plurality of types of standard cells arbitrarily combinable to form an I/O circuit of a semiconductor device. The cell library has a configuration (a ninth configuration) in which at least one of the plurality of types of standard cells includes a first element forming region configured so that a protection target element having a gate electrically connected to an external terminal is formed therein, a second element forming region arranged in immediate proximity to the external terminal and configured so that a first protection element for protecting the protection target element from electrostatic breakdown is formed therein, and a third element forming region arranged between the first element forming region and the second element forming region and configured so that a first transistor and a second transistor are formed therein. At least one of the first transistor and the second transistor has a drain connected to a gate of the protection target element and a source, a gate, and a back gate all connected to a constant potential terminal, thus functioning as a second protection element for protecting the protection target element from electrostatic breakdown.

Furthermore, for example, a circuit designing method for a semiconductor device as disclosed in the present description has a configuration (a tenth configuration) using the cell library according to the above-described ninth configuration and including a step of selecting, arranging, and thereby arbitrarily combining the plurality of types of standard cells contained in the cell library and a step of laying a power supply line and a signal line so as to establish connection between the plurality of types of standard cells thus arbitrarily combined and any other circuit block.

According to the disclosure in the present description, it becomes possible to provide an I/O circuit that achieves both of an improvement in ESD immunity and an area reduction.

### Other Modification Examples

Besides the foregoing embodiment, the various technical features disclosed in the present description can be variously modified without departing from the spirit of the technical ingenuity involved. That is, the foregoing embodiment is to be construed in all respects as illustrative and not limiting. The technical scope of the present disclosure is defined by the appended claims, and it is to be understood that all changes that come within the meaning and range of equivalency of the claims are intended to be embraced therein.

1. An I/O circuit formed by arbitrarily combining a plurality of types of standard cells contained in a cell library, at least one of the plurality of types of standard cells comprising:
a first element forming region configured so that a protection target element having a gate electrically connected to an external terminal is formed therein;
a second element forming region arranged in immediate proximity to the external terminal and configured so that a first protection element for protecting the protection target element from electrostatic breakdown is formed therein; and
a third element forming region arranged between the first element forming region and the second element forming region and configured so that a first transistor and a second transistor are formed therein,
wherein
at least one of the first transistor and the second transistor has a drain connected to a gate of the protection target element and a source, a gate, and a back gate all connected to a constant potential terminal, thus functioning as a second protection element for protecting the protection target element from electrostatic breakdown.

2. The I/O circuit according to claim 1, wherein
the first protection element includes:
a first upper protection element configured to be connected between the gate of the protection target element and a power supply terminal; and
a first lower protection element configured to be connected between the gate of the protection target element and a ground terminal.

3. The I/O circuit according to claim 1, wherein
the first transistor has a drain connected to the gate of the protection target element and a source, a gate, and a back gate all connected to a power supply terminal, thus functioning as a second upper protection element, and
the second transistor has a drain connected to the gate of the protection target element, a source and a back gate both connected to a ground terminal, and a gate connected to a bias potential terminal, thus functioning as a pull-down element and a second lower protection element.

4. The I/O circuit according to claim 1, wherein
the first transistor has a drain connected to the gate of the protection target element, a source and a back gate both connected to a power supply terminal, and a gate connected to a bias potential terminal, thus functioning as a pull-up element and a second upper protection element, and
the second transistor has a drain connected to the gate of the protection target element and a source, a gate, and a back gate all connected to a ground terminal, thus functioning as a second lower protection element.

5. The I/O circuit according to claim 1, wherein
the first transistor has a drain connected to the gate of the protection target element and a source, a gate, and a back gate all connected to a power supply terminal, thus functioning as a second upper protection element, and
the second transistor has a drain connected to the gate of the protection target element and a source, a gate, and a back gate all connected to a ground terminal, thus functioning as a second lower protection element.

6. The I/O circuit according to claim 1, wherein
the protection target element includes:
a P-channel transistor configured to have a source and a back gate both connected to a power supply terminal, a drain connected to an output terminal, and a gate connected to the external terminal; and
an N-channel transistor configured to have a drain connected to the output terminal, a source and a back gate both connected to a ground terminal, and a gate connected to the external terminal.

7. The I/O circuit according to claim 1, further comprising:
a fourth element forming region arranged between the first element forming region and the second element forming region and configured so that a current limiting resistor connected between the gate of the protection target element and the external terminal is formed therein.

8. A semiconductor device comprising the I/O circuit according to claim 1.

9. A cell library that is read out from a circuit designing program executed on a computer and contains a plurality of types of standard cells arbitrarily combinable to form an I/O circuit of a semiconductor device, at least one of the plurality of types of standard cells comprising:
a first element forming region configured so that a protection target element having a gate electrically connected to an external terminal is formed therein;
a second element forming region arranged in immediate proximity to the external terminal and configured so that a first protection element for protecting the protection target element from electrostatic breakdown is formed therein; and
a third element forming region arranged between the first element forming region and the second element forming region and configured so that a first transistor and a second transistor are formed therein,
wherein
at least one of the first transistor and the second transistor has a drain connected to a gate of the protection target element and a source, a gate, and a back gate all connected to a constant potential terminal, thus functioning as a second protection element for protecting the protection target element from electrostatic breakdown.

10. A circuit designing method for a semiconductor device, the method using the cell library according to claim 9 and comprising:
a step of selecting, arranging, and thereby arbitrarily combining the plurality of types of standard cells contained in the cell library; and
a step of laying a power supply line and a signal line so as to establish connection between the plurality of types of standard cells thus arbitrarily combined and any other circuit block.
